(19) United States
(12) Patent Application Publication
(10) Pub. No.: US 2026/0285694 A1
(43) Pub. Date: Sep. 24, 2026

(54) Method for Producing Purified Trichlorosilane

(71) Applicant: Tokuyama Corporation, Yamaguchi (JP)

(72) Inventors: Junya Sakai, Yamaguchi (JP); Shoji Iiyama, Yamaguchi (JP)

(73) Assignee: Tokuyama Corporation, Yamaguchi (JP)

(21) Appl. No.: 18/873,773

(22) PCT Filed: Jun. 5, 2023
(86) PCT No.: PCT/JP2023/020839

§ 371 Date: Dec. 11, 2024

(30) Foreign Application Priority Data
Jun. 13, 2022 (JP) 2022-095014

(51) Int. Cl. C01B 33/107; B01D 3/14

(52) U.S. Cl. CPC C01B 33/10778; B01D 3/143; C01B 33/10763; C01P 2006/80

(57) ABSTRACT

A method for producing purified trichlorosilane includes supplying crude trichlorosilane containing at least isopentane and methyldichlorosilane to a first distillation column, purifying the crude trichlorosilane by distillation in a manner that a low boiling point fraction having an isopentane concentration 150 times or more higher than an isopentane concentration in the crude trichlorosilane is discharged, and extracting trichlorosilane having a reduced isopentane concentration from a bottom of the column; and then supplying the obtained trichlorosilane having a reduced isopentane concentration to a second distillation column, purifying the obtained trichlorosilane having a reduced isopentane concentration by distillation in a manner that a high boiling point fraction having a methyldichlorosilane concentration 1.5 times or more higher than a methyldichlorosilane concentration in the crude trichlorosilane is discharged, and distilling off purified trichlorosilane having a reduced methyldichlorosilane concentration from a top of the column.

### TECHNICAL FIELD

The present invention relates to a method for producing purified trichlorosilane, particularly to a method for purifying crude trichlorosilane containing at least isopentane and methyldichlorosilane by distillation to obtain purified trichlorosilane.

### BACKGROUND ART

In the related art, high-purity trichlorosilane (SiHCl₃) has been used as a raw material for producing polycrystalline silicon (Si). The polycrystalline silicon is used, for example, as a raw material for a semiconductor or a photovoltaic power generation wafer.

As a method for producing trichlorosilane, a method of reacting a gas containing hydrogen chloride or silicon tetrachloride and hydrogen with metallurgical grade silicon is known.

Specifically, a method of subjecting metallurgical grade silicon and a hydrogen chloride-containing gas to a hydrochlorination reaction at a temperature of 250° C. or higher, generally 250° C. to 450° C., or a method of subjecting metallurgical grade silicon and a mixed gas containing silicon tetrachloride and hydrogen to a hydrochlorination reaction at a temperature of 400° C. or higher, generally 400° C. to 600° C. is known. The trichlorosilane is also known to be produced as a by-product by subjecting metallurgical grade silicon and a mixed gas containing a chlorinated hydrocarbon and hydrogen to a hydrochlorination reaction or the like.

The trichlorosilane produced by these methods is crude trichlorosilane mixed with various by-product impurities generated by a side reaction along with the generation of the trichlorosilane or a side reaction caused by hydrochlorination of a carbon impurity contained in the metallurgical grade metal silicon as a raw material. Representative examples of the by-product impurities include a low boiling point impurity having a boiling point lower than a boiling point of trichlorosilane to be purified (boiling point: 31.8° C.), such as dichlorosilane (H₂SiCl₂, boiling point: 8.4° C.) and tetramethylsilane (Si(CH₃)₄, boiling point: 27° C.), a high boiling point impurity having a boiling point higher than the boiling point of the trichlorosilane, such as silicon tetrachloride (SiCl₄, boiling point: 57.7° C.), trimethylchlorosilane ((CH₃)₃SiCl, boiling point: 57° C.), and dimethyldichlorosilane ((CH₃)₂SiCl₂, boiling point: 70° C.), and a close boiling point impurity having a boiling point close to the boiling point of the trichlorosilane, such as isopentane (CH₃CH₂CH(CH₃)₂, boiling point: 27.7° C.) and methyldichlorosilane (CH₃SiHCl₂, boiling point: 42° C.). In the present description, the boiling point refers to a value under normal pressure (1 atmosphere). In order to remove the by-product impurities contained in the crude trichlorosilane, purification by distillation has been performed in the related art. (For example, paragraph [0028] in Patent Literature 1, and paragraph [0007] and FIG. 1 in Patent Literature 2).

### Citation List

### Patent Literature

Patent Literature 1: Japanese Patent Laid-Open No. 2018-052765
Patent Literature 2: Japanese Patent Laid-Open No. 2014-152093

### SUMMARY OF INVENTION

### Technical Problem

According to the above purification by distillation, among the by-product impurities contained in the crude trichlorosilane, the low boiling point impurity and the high boiling point impurity having a large boiling point difference from the trichlorosilane can be removed without much difficulty as a distillate or a column bottom liquid from a distillation column. However, needless to say, purification by distillation is a separation method that utilizes a boiling point difference between substances, and thus separation of substances having a small boiling point difference, that is, the close boiling point impurity shown as the by-product impurities contained in the above crude trichlorosilane, is insufficient (for example, paragraph [0028] in Patent Literature 1 and paragraph [0012] in Patent Literature 2). In particular, the isopentane has a boiling point of 27.7° C., which is extremely close to the boiling point of the trichlorosilane, i.e., 31.8° C., and further, the isopentane may form an azeotrope with chlorosilanes including the trichlorosilane, making it extremely difficult to highly purify the trichlorosilane.

Specifically, in the above Patent Literature 2, crude trichlorosilane having a high content of methyldichlorosilane, obtained by removing low boiling point methylchlorosilanes and high boiling point impurities such as silicon tetrachloride (FIG. 1 and paragraph [0045]), is subjected to a chlorine atom redistribution reaction including a specific step to obtain a fraction having a low content of the above methyldichlorosilane. Then, the fraction having a low content of methyldichlorosilane is distilled again to obtain trichlorosilane from which the methyldichlorosilane has been greatly removed (paragraph [0050]). In this method, nothing is made clear as to whether the isopentane is contained in the crude trichlorosilane. In this method, certainly, the methyldichlorosilane may be removed to some extent, but when the above isopentane is contained, most of the isopentane is not removed and remains in the obtained purified trichlorosilane.

In recent years, there has been an increasing demand for reducing an amount of carbon impurities as much as possible in a silicon single crystal, which is used as a raw material for producing a semiconductor device, because the carbon impurities have a detrimental effect on electrical properties of the silicon single crystal. Under this background, in trichlorosilane which is a raw material for producing polycrystalline silicon for producing the above silicon single crystal, it is desired to reduce, as much as possible, a content of hydrocarbons that generate such carbon impurities. However, the above close boiling point impurities, in particular, isopentane, cannot be sufficiently removed, which poses a major problem that it is difficult to achieve the reduction.

### Solution to Problem

The present inventors have continued intensive research in view of the above problems. As a result, the inventors have found that the above problems can be solved by subjecting crude trichlorosilane containing at least isopentane and methyldichlorosilane to specific two-stage distillation. Thus, the present invention has been completed.

That is, the present invention provides a method for producing purified trichlorosilane, including:
supplying crude trichlorosilane containing at least isopentane and methyldichlorosilane to a first distillation column, purifying the crude trichlorosilane by distillation in a manner that a low boiling point fraction having an isopentane concentration 150 times or more higher than an isopentane concentration in the crude trichlorosilane is discharged, and extracting trichlorosilane having a reduced isopentane concentration from a bottom of the column; and then
supplying the obtained trichlorosilane having a reduced isopentane concentration to a second distillation column, purifying the obtained trichlorosilane having a reduced isopentane concentration by distillation in a manner that a high boiling point fraction having a methyldichlorosilane concentration 1.5 times or more higher than a methyldichlorosilane concentration in the crude trichlorosilane is discharged, and distilling off purified trichlorosilane having a reduced methyldichlorosilane concentration from a top of the column.

### Advantageous Effects of Invention

According to the method of the present invention, in crude trichlorosilane containing at least isopentane and methyldichlorosilane, it is possible to highly reduce a close boiling point impurity, in particular, isopentane, which is difficult to separate from the trichlorosilane, by a simple method. As a result, polycrystalline silicon produced using the obtained purified trichlorosilane as a raw material has an extremely low amount of carbon impurities, which in turn makes it possible to produce a high-purity silicon single crystal for use as a raw material for producing a semiconductor device, making it extremely useful in industry.

### BRIEF DESCRIPTION OF DRAWINGS

FIG. 1 is a distillation flow diagram showing an exemplary embodiment of a method for producing purified trichlorosilane in the present invention.

FIG. 2 is a distillation flow diagram showing a method for producing purified trichlorosilane performed in Comparative Example 1.

### DESCRIPTION OF EMBODIMENTS

In a method according to the present invention, crude trichlorosilane used to produce purified trichlorosilane contains at least both isopentane and methyldichlorosilane. The crude trichlorosilane is usually obtained by reacting a gas containing hydrogen chloride or silicon tetrachloride and hydrogen with metallurgical grade silicon.

Specifically, the crude trichlorosilane is suitably obtained by a method of subjecting metallurgical grade silicon and a hydrogen chloride-containing gas to a hydrochlorination reaction at a temperature of 250° C. or higher, generally 250° C. to 450° C., or a method of subjecting metallurgical grade silicon and a mixed gas containing silicon tetrachloride and hydrogen to a hydrochlorination reaction at a temperature of 400° C. or higher, generally 400° C. to 600° C. The crude trichlorosilane is generally prepared by cooling a reaction gas generated by the above reaction to form a condensate, and feeding the condensate to a crude trichlorosilane recovery column to separate and remove impurities having a boiling point higher than that of silicon tetrachloride, specifically a metal chloride such as iron chloride.

In addition, crude trichlorosilane obtained by subjecting metallurgical grade silicon and a mixed gas containing chlorinated hydrocarbon and hydrogen to a hydrochlorination reaction can also be favorably used.

Such crude trichlorosilane usually contains 10 mol % to 40 mol %, preferably 20 mol % to 30 mol %, of trichlorosilane. On the other hand, crude trichlorosilane usually contains, as impurities, 30 ppb by mole to 200 ppb by mole, more specifically 50 ppb by mole to 100 ppb by mole of the isopentane; and 1,000 ppb by mole to 20,000 ppb by mole, more specifically 6,000 ppb by mole to 10,000 ppb by mole of methyldichlorosilane. In addition to these close boiling point impurities, the crude trichlorosilane usually contains 0.1 mol % to 10 mol %, more specifically 0.2 mol % to 2 mol % of dichlorosilane, as a low boiling point impurity, and usually contains 50 mol % to 89.9 mol %, more specifically 70 mol % to 80 mol % of silicon tetrachloride, as a high boiling point impurity. The content of the above component refers to a concentration of the above component. Further, a low boiling point impurity such as tetramethylsilane and a high boiling point impurity such as trimethylchlorosilane and dimethyldichlorosilane may also be contained.

In the present specification, the concentrations of impurities such as isopentane and silanes such as methyldichlorosilane, silicon tetrachloride, and dichlorosilane, contained in the above trichlorosilane are values measured by a gas chromatograph.

In the method according to the present invention, the crude trichlorosilane containing at least isopentane and methyldichlorosilane is purified by specific distillation using a combination of a first distillation column and a second distillation column, which will be described later. Each distillation column to be used may be either a tray type distillation column or a packed type distillation column. In the tray type, the actual number of trays is not particularly limited, and is, for example, 10 or more and 150 or less, and more preferably 20 or more and 100 or less. In the packed type, examples of a packing include a Raschig ring and a Lessing ring. The distillation column can be operated in either a batch or continuous manner.

In the method according to the present invention, the crude trichlorosilane is first supplied to the first distillation column for purification. In the purification in the first distillation column, distillation removal of isopentane, one of the close boiling point impurities, is performed. The greatest feature of the present invention is that the distillation removal of isopentane is performed prior to distillation removal of methyldichlorosilane, which is another component of the close boiling point impurities. In other words, the distillation removal of isopentane is performed in coexistence of the methyldichlorosilane. Accordingly, in the distillation in the first distillation column, a low boiling point fraction having an isopentane concentration 150 times or more higher than an isopentane concentration in the crude trichlorosilane is discharged, making it possible to extract trichlorosilane having a reduced isopentane concentration from a bottom of the column. It is particularly preferable that the isopentane concentration in the above low boiling point fraction is 200 times or more and 300 times or less higher than the isopentane concentration in the crude trichlorosilane.

Here, as described above, among the close boiling point impurities of the trichlorosilane, isopentane has a particularly small boiling point difference from the trichlorosilane, and also exhibits a property of forming an azeotrope with chlorosilanes, and separation by distillation is particularly difficult. With this property, when the distillation is performed in the coexistence of methyldichlorosilane as described above, it is possible to highly remove the isopentane.

Specifically, even when the content of the isopentane (isopentane concentration) in the crude trichlorosilane is 30 ppb by mole or more, more specifically 50 ppb by mole to 100 ppb by mole, it is possible to reduce the content of the isopentane to 20 ppb by mole or less, more preferably 10 ppb by mole to 19 ppb by mole.

The boiling point difference between isopentane and trichlorosilane is 4.1° C., and a boiling point difference between methyldichlorosilane and trichlorosilane is 10° C. As described above, the isopentane concentration in the crude trichlorosilane is about 30 ppb by mole to 200 ppb by mole, and a methyldichlorosilane concentration in the crude trichlorosilane is about 2,000 ppb by mole to 20,000 ppb by mole.

When a substance containing a component to be purified, a component having a boiling point lower than that of the component to be purified, and a component having a boiling point higher than that of the component to be purified is distilled to obtain the component to be purified, which component is removed first (the order in which a distillation operation is performed) is determined in consideration of a boiling point difference between components to be removed (low boiling point component and high boiling point component) and the component to be purified, and the contents of the components to be removed.

Considering the efficiency and the cost of a distillation operation, a distillation operation is usually performed to remove, among the components to be removed, a component that has a large boiling point difference from the component to be purified, and then a distillation operation is performed to remove, among the components to be removed, a component that has a small boiling point difference from the component to be purified. Similarly, a distillation operation is usually performed to remove, among the components to be removed, a component that is present in a large content, and then a distillation operation is performed to remove, among the components to be removed, a component that is present in a small content. In particular, in a distillation column that separates a top component and a bottom component, it is preferable to first perform the distillation operation to remove the component that is present in a large content.

Therefore, when crude trichlorosilane is distilled to separate isopentane and methyldichlorosilane from the crude trichlorosilane, from the viewpoint of both the boiling point difference and the content, the methyldichlorosilane should be first removed by a distillation operation, and then the isopentane should be removed by a distillation operation.

However, when the methyldichlorosilane is first removed by distillation and then an isopentane distillation removal operation is performed, the isopentane concentration in the trichlorosilane is obtained as a value that is reduced to a certain extent in a gas chromatograph analysis. Nevertheless, a phenomenon occurs, in which an effect of removing a carbon impurity derived from the isopentane is actually insufficient and the content of the carbon impurity in polycrystalline silicon produced using the purified trichlorosilane is not sufficiently reduced. That is, when the methyldichlorosilane distillation removal operation is performed first, an isopentane reduction effect obtained by performing the above isopentane distillation removal operation in the coexistence of the methyldichlorosilane cannot be obtained.

A reason is not entirely clear, and the present inventors presume that this is because the methyldichlorosilane has an action of inhibiting formation of an azeotrope between the isopentane and the chlorosilanes. That is, in the coexistence of the methyldichlorosilane, the isopentane exists alone in the trichlorosilane, and by distilling the isopentane off, a higher level of purification is possible. On the other hand, when the methyldichlorosilane is removed first, it is considered that the isopentane forms an azeotrope with various silanes including the trichlorosilane. Among these, a boiling point of the azeotrope between the isopentane and the trichlorosilane is closer to that of the trichlorosilane than that of the isopentane.

Here, it is difficult to detect such an azeotrope by gas chromatograph analysis, which is usually used to measure a purity of the trichlorosilane. Therefore, even when it is determined that the purified trichlorosilane has a greatly reduced isopentane concentration by, for example, the gas chromatograph analysis, it is considered that most of the isopentane actually remains in a form of the azeotrope. Thus, even when polycrystalline silicon is produced using the purified trichlorosilane, the obtained polycrystalline silicon contains a large amount of carbon impurities derived from the isopentane azeotrope, resulting in an insufficient reduction in the carbon content (carbon concentration).

As described above, this is because, although the isopentane can be detected in a gas chromatograph column used in purity measurement of the trichlorosilane, it is difficult to detect the isopentane azeotrope. Therefore, it is considered that the isopentane azeotrope that is not detected in the purified trichlorosilane is converted to carbon in a step of producing polycrystalline silicon using the purified trichlorosilane, and is detected as a carbon impurity in the polycrystalline silicon.

In the distillation in the first distillation column, discharge of the low boiling point fraction having an isopentane concentration 150 times or more higher than the isopentane concentration in the crude trichlorosilane may be performed by heating the crude trichlorosilane stored in a bottom portion and appropriately setting a distillation condition to discharge the above low boiling point fraction at the top or an upper part of the side of the column. For example, a temperature at the top portion or the upper part of the side of the column is set to about 50° C. to 53° C.

In addition, in the first distillation column, a part of a distillate from the top of the column is preferably condensed by cooling and refluxed. At this time, the higher the reflux ratio, the better the separation efficiency, and it is set appropriately taking productivity into consideration.

Next, in the first distillation column, the trichlorosilane having a reduced isopentane concentration, which is extracted from the bottom of the column, is supplied to the second distillation column for purification. In the purification in the second distillation column, distillation removal of the remaining methyldichlorosilane among the close boiling point impurities is performed. Specifically, the trichlorosilane having a reduced isopentane concentration is purified by distillation in a manner that the high boiling point fraction having a methyldichlorosilane concentration 1.5 times or more higher than the methyldichlorosilane concentration in the crude trichlorosilane is discharged, and the purified trichlorosilane having a reduced methyldichlorosilane concentration is distilled from the top of the column. Here, it is particularly preferable that the methyldichlorosilane concentration in the above high boiling point fraction is 2 times to 5 times higher than the methyldichlorosilane concentration in the crude trichlorosilane.

In the distillation in the second distillation column, discharge of the high boiling point fraction having a methyldichlorosilane concentration 1.5 times or more higher than the methyldichlorosilane concentration in the crude trichlorosilane may be performed by heating the trichlorosilane having a reduced isopentane concentration supplied from the first distillation column and stored at the bottom portion and appropriately setting a distillation condition to extract the above high boiling point fraction at a bottom portion or a lower part of the side of the column. For example, a temperature at the bottom portion or the lower part of the side of the column is set to about 64° C. to 67° C.

In the second distillation column, as in the case of the first distillation column, a part of a distillate from the top of the column is preferably condensed by cooling and refluxed. At this time, the higher the reflux ratio, the better the separation efficiency, and it is set appropriately taking productivity into consideration.

Specifically, the removal of the methyldichlorosilane in the above second distillation column can reduce the content of the methyldichlorosilane to 100 ppb by mole or less, more preferably 50 ppb by mole to 90 ppb by mole, even when the content of the methyldichlorosilane (methyldichlorosilane concentration) in the trichlorosilane having reduced isopentane is 1,000 ppb by mole or more, more specifically 2,000 ppb by mole to 20,000 ppb by mole. Thus, according to the present invention, it is possible to obtain clean purified trichlorosilane having an isopentane content (isopentane concentration) of 20 ppb by mole or less and a methyldichlorosilane content (methyldichlorosilane concentration) of 100 ppb by mole or less. In this purified trichlorosilane contains, not only the content of the detectable isopentane, but also the content of the azeotrope of isopentane and trichlorosilane, which is difficult to detect, is extremely low. Therefore, polycrystalline silicon produced using the purified trichlorosilane has a highly reduced carbon impurity content (carbon concentration).

In the distillation in the above second distillation column, the high boiling point fraction discharged from the second distillation column and having a methyldichlorosilane concentration 1.5 times or more higher than the methyldichlorosilane concentration in the crude trichlorosilane may be supplied to a third distillation column, and may be purified by distillation again in a manner that a high boiling point fraction having a methyldichlorosilane concentration higher than (preferably 10 times or more) a methyldichlorosilane concentration in the crude trichlorosilane in the third distillation column is discharged, and purified trichlorosilane having a reduced methyldichlorosilane concentration and distilled from the top of the column may be obtained. The purified trichlorosilane obtained in the third distillation column can also have a comparable isopentane content (isopentane concentration) and methyldichlorosilane content (methyldichlorosilane concentration) as the purified trichlorosilane discharged from the top of the second distillation column.

As described above, the crude trichlorosilane usually contains dichlorosilane as the low boiling point impurity and silicon tetrachloride as the high boiling point impurity in addition to the close boiling point impurities (isopentane and methyldichlorosilane). It is preferable to highly remove these low boiling point impurity and high boiling point impurity. In order to highly remove these low boiling point impurity and high boiling point impurity, in the present embodiment, it is desirable to perform the following pre-purification before supplying the crude trichlorosilane to the first distillation column, that is, before performing the distillation operation of removing the close boiling point impurities.

That is, in the [pre-purification],
the crude trichlorosilane is supplied to a pre-first distillation column, and purified by distillation in a manner that a high boiling point fraction having a silicon tetrachloride concentration 1.1 times or more higher than a silicon tetrachloride concentration in the crude trichlorosilane is discharged, and crude trichlorosilane having a reduced silicon tetrachloride concentration is distilled from a top of the column, and then
the obtained crude trichlorosilane having a reduced silicon tetrachloride concentration is supplied to a pre-second distillation column, and purified by distillation in a manner that a low boiling point fraction having a dichlorosilane concentration 100 times or more higher than a dichlorosilane concentration in the crude trichlorosilane is discharged, and crude trichlorosilane having a reduced dichlorosilane concentration is extracted from a bottom of the column and supplied to the first distillation column. In the present specification, the crude trichlorosilane having a reduced dichlorosilane concentration that is extracted from the bottom of the pre-second distillation column is also referred to as pre-purified trichlorosilane.

In the above pre-purification, in the purification in the pre-first distillation column, distillation removal of silicon tetrachloride, which is a high boiling point impurity and has a high content (high concentration) in the crude trichlorosilane, is performed. Specifically, the crude trichlorosilane is purified by distillation in a manner that a high boiling point fraction having a silicon tetrachloride concentration 1.1 times or more higher than a silicon tetrachloride concentration in the crude trichlorosilane is discharged, and the trichlorosilane having a reduced silicon tetrachloride concentration is distilled from the top of the column. Here, it is particularly preferable that the silicon tetrachloride concentration in the above high boiling point fraction is 1.2 times to 2 times higher than the silicon tetrachloride concentration in the crude trichlorosilane.

In the distillation in the pre-first distillation column, discharge of the high boiling point fraction having a silicon tetrachloride concentration 1.1 times higher than the silicon tetrachloride concentration in the crude trichlorosilane may be performed by heating the crude trichlorosilane stored at the bottom portion and appropriately setting a distillation condition to extract the above high boiling point fraction at a bottom portion or a lower part of the side of the column. For example, a temperature at the bottom portion or the lower part of the side of the column is set to about 90° C. to 93° C. The high boiling point fraction may contain a solid such as an unreacted silicon fine powder.

In the pre-first distillation column, as in the case of the first distillation column, a part of a distillate from the top of the column is preferably condensed by cooling and refluxed. At this time, the higher the reflux ratio, the better the separation efficiency, and it is set appropriately taking productivity into consideration.

According to the purification by distillation in the pre-first distillation column, even when the content of the silicon tetrachloride (silicon tetrachloride concentration) in the crude trichlorosilane is 50 mol % or more, more specifically 50 mol % to 89.9 mol %, it is possible to reduce the content (concentration) to 0.1 mol % or less, more preferably to 10 ppm by mole (TCD detection limit value) or less.

In the pre-purification, in the subsequent purification in the pre-second distillation column, distillation removal of dichlorosilane, which is a low boiling point impurity and has a relatively high content (relatively high concentration) in the crude trichlorosilane, is performed. Specifically, the crude trichlorosilane having a reduced silicon tetrachloride concentration is purified by distillation in a manner that a low boiling point fraction having a dichlorosilane concentration 100 times or more higher than a dichlorosilane concentration in the crude trichlorosilane is discharged, and trichlorosilane having a reduced dichlorosilane concentration is extracted from the bottom of the column. Here, it is particularly preferable that the dichlorosilane concentration in the above low boiling point fraction is 100 times to 200 times higher than the dichlorosilane concentration in the crude trichlorosilane.

In the distillation in the pre-second distillation column, discharge of the low boiling point fraction having a dichlorosilane concentration 100 times or more higher than the dichlorosilane concentration in the crude trichlorosilane may be performed by heating the trichlorosilane having reduced silicon tetrachloride stored in the bottom portion and appropriately setting a distillation condition to discharge the above low boiling point fraction from a top or an upper part of the side of the column. For example, a temperature at the top portion or the upper part of the side of the column is set to about 40° C. to 43° C.

In the pre-second distillation column, as in the case of the first distillation column, a part of a distillate from the top of the column is preferably condensed by cooling and refluxed. At this time, the higher the reflux ratio, the better the separation efficiency, and it is set appropriately taking productivity into consideration.

According to the distillation purification in the pre-second distillation column, even when the content of the dichlorosilane (dichlorosilane concentration) in the trichlorosilane having a reduced silicon tetrachloride concentration is 0.1 mol % or more, more specifically 0.2 mol % to 2 mol %, it is possible to reduce the content (concentration) to less than 0.1 mol %, more preferably to 10 ppm by mole (TCD detection limit value) or less. Thus, according to the pre-purification, it is possible to obtain the trichlorosilane having a reduced dichlorosilane concentration, that is, the pre-purified trichlorosilane, which is extracted from the bottom of the pre-second distillation column. In the pre-purified trichlorosilane, the contents (concentrations) of the silicon tetrachloride and the dichlorosilane are both at a clean level of 10 ppm by mole or less (TCD detection limit value), and it is possible to supply the pre-purified trichlorosilane to the first distillation column. Therefore, in the pre-purified trichlorosilane, the content of the trichlorosilane (trichlorosilane concentration) is preferably 99 mol % or more, more preferably 99.5 mol % or more, and even more preferably 99.9 mol % or more.

Even when a removal operation for the silicon tetrachloride, the dichlorosilane, and the like, which are impurities having a large boiling point difference from the trichlorosilane is performed by the pre-purification, the contents (concentrations) of the isopentane and the methyldichlorosilane which are close boiling point impurities contained in the crude trichlorosilane are not substantially reduced. Therefore, it is general that the concentrations of these close boiling point impurities in the crude trichlorosilane (crude trichlorosilane before pre-purification) containing the silicon tetrachloride and the dichlorosilane are substantially the same as the concentrations of these close boiling point impurities in the pre-purified trichlorosilane. However, when there is a large change, in the removal of these close boiling point impurities, which is performed by combining the subsequent first distillation column and second distillation column, reference concentrations of the isopentane and the methyldichlorosilane before discharge may be determined based on the concentrations thereof in the above pre-purified trichlorosilane immediately before a removal treatment.

Further, the purified trichlorosilane obtained by the method according to the present invention may be appropriately subjected to a further purification treatment such as adsorption removal, or a mixing treatment of mixing with trichlorosilane recovered from an exhaust gas after precipitating the polycrystalline silicon using the purified trichlorosilane.

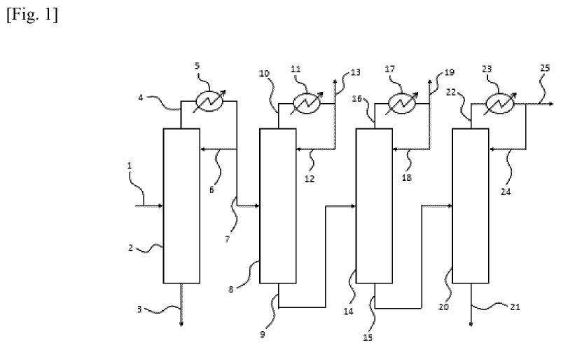

The above-described method for producing purified trichlorosilane is more specifically shown in FIG. 1, which is a distillation flow diagram showing an embodiment including pre-purification. In FIG. 1, a liquid flow of crude trichlorosilane generated by reacting a gas containing hydrogen chloride or silicon tetrachloride and hydrogen with metallurgical grade silicon flows through a crude trichlorosilane flow pipe 1. In addition to the isopentane and the methyldichlorosilane, the crude trichlorosilane contains silicon tetrachloride or the like which is a high boiling point impurity, and dichlorosilane or the like which is a low boiling point impurity.

The crude trichlorosilane is first subjected to the pre-purification to remove the silicon tetrachloride which is the above high boiling point impurity and the dichlorosilane which is the low boiling point impurity. That is, the crude trichlorosilane flow pipe 1 is connected to a side of a pre-first distillation column 2, and the above liquid flow of the crude trichlorosilane is supplied to the pre-first distillation column 2. In the pre-first distillation column 2, the above crude trichlorosilane liquid stored in a bottom portion is heated and purified by distillation under the above condition. By the purification by distillation, a column bottom liquid corresponding to a high boiling point fraction having a silicon tetrachloride concentration 1.1 times or more higher than a silicon tetrachloride concentration in the crude trichlorosilane is extracted from a bottom of the column into a silicon tetrachloride-concentrated column bottom liquid extraction pipe 3, and on the other hand, a gaseous phase of trichlorosilane having a reduced silicon tetrachloride concentration is distilled from a top of the column into a silicon tetrachloride-reduced trichlorosilane distillation pipe 4.

The gaseous phase of the trichlorosilane having reduced silicon tetrachloride, which is distilled into the silicon tetrachloride-reduced trichlorosilane distillation pipe 4 is liquefied by a condenser 5, and a part of a liquid flow thereof is refluxed to the pre-first distillation column 2 through a silicon tetrachloride-reduced trichlorosilane reflux pipe 6. On the other hand, another silicon tetrachloride-reduced trichlorosilane supply pipe 7 branched from the silicon tetrachloride-reduced trichlorosilane reflux pipe 6 is connected to a side of a pre-second distillation column 8, and the remaining liquid flow of the silicon tetrachloride-reduced trichlorosilane refluxed to the pre-first distillation column 2 is supplied to the pre-second distillation column 8. Then, in the pre-second distillation column 8, the above silicon tetrachloride-reduced trichlorosilane liquid stored in a bottom portion is heated and purified by distillation under the above condition. By the purification by distillation, a gaseous phase corresponding to a low boiling point fraction having a dichlorosilane concentration 100 times or more higher than a dichlorosilane concentration in the crude trichlorosilane is distilled from the top of the column into a dichlorosilane concentrate distillation pipe 10, and on the other hand, a liquid flow of pre-purified trichlorosilane having a reduced dichlorosilane concentration is extracted from a bottom of the column into a pre-purified trichlorosilane extraction pipe 9.

The gaseous phase of the dichlorosilane concentrate distilled into the dichlorosilane concentrate distillation pipe 10 is liquefied by a condenser 11, and a part of a liquid flow thereof is refluxed to the pre-second distillation column 8 through a dichlorosilane concentrate reflux pipe 12. On the other hand, the remaining dichlorosilane concentrate is fed outside of the system through another dichlorosilane concentrate flow pipe 13 branched from the dichlorosilane concentrate reflux pipe 12.

After the above pre-purification, isopentane and methyldichlorosilane are removed from the pre-purified trichlorosilane that flows through the above pre-purified trichlorosilane extraction pipe 9 and from which the silicon tetrachloride and the dichlorosilane have been removed. That is, the pre-purified trichlorosilane extraction pipe 9 is connected to a side of a first distillation column 14, and the above liquid flow of the pre-purified trichlorosilane is supplied to the first distillation column 14. Then, in the first distillation column 14, the above pre-purified trichlorosilane liquid stored in a bottom portion is heated and purified by distillation under the above condition. By the purification by distillation, a gaseous phase corresponding to a low boiling point fraction having an isopentane concentration 150 times or more higher than an isopentane concentration in the crude trichlorosilane is distilled from a top of the column into an isopentane concentrate distillation pipe 16, and on the other hand, a liquid flow of trichlorosilane having a reduced isopentane concentration is extracted from a bottom of the column into an isopentane-reduced trichlorosilane extraction pipe 15.

The gaseous phase of the isopentane concentrate distilled into the isopentane concentrate distillation pipe 16 is liquefied by a condenser 17, and a part of a liquid flow thereof is refluxed to the first distillation column 14 through an isopentane concentrate reflux pipe 18. On the other hand, the remaining isopentane concentrate is fed outside of the system through another isopentane concentrate flow pipe 19 branched from the isopentane concentrate reflux pipe 18.

The above isopentane-reduced trichlorosilane extraction pipe 15 is connected to a side of a second distillation column 20, and the above liquid flow of the isopentane-reduced trichlorosilane is supplied to the second distillation column 20. Then, in the second distillation column 20, the above isopentane-reduced trichlorosilane liquid stored in a bottom portion is heated and purified by distillation under the above condition. By the purification by distillation, a column bottom liquid corresponding to a high boiling point fraction having a methyldichlorosilane concentration 1.5 times or more higher than a methyldichlorosilane concentration in the crude trichlorosilane is extracted from a bottom of the column into a methyldichlorosilane-concentrated column bottom liquid extraction pipe 21, and on the other hand, a gaseous phase of trichlorosilane having a reduced methyldichlorosilane concentration is distilled from a top of the column into a purified trichlorosilane distillation pipe 22.

The gaseous phase of the purified trichlorosilane distilled into the purified trichlorosilane distillation pipe 22 is liquefied by a condenser 23, and a part of a liquid flow thereof is refluxed to the second distillation column 20 through a purified trichlorosilane reflux pipe 24. Then, the purified trichlorosilane that has been subjected to the producing method according to the present invention is taken out as a remaining liquid from another purified trichlorosilane flow pipe 25 branched from the purified trichlorosilane reflux pipe 24. The purified trichlorosilane obtained in this way is sufficiently useful used as a raw material for producing polycrystalline silicon or the like.

### EXAMPLES

Hereinafter, Examples will be shown to specifically explain the present invention, but the present invention is not limited to these Examples. Measurement and evaluation performed in Examples and Comparative Examples were performed by the following methods.

### (1) Analysis Method for Each Component

A concentration of chlorosilanes was measured using a gas chromatograph equipped with a thermal conductivity detector (TCD detector) (a lower detection limit value for the chlorosilanes was 10 ppm by mole). A concentration of a carbon-containing compound was measured using a gas chromatograph equipped with a mass spectrometer (MS) as a detector (GCMS) (a lower detection limit value was 1 ppb by mole), and a concentration of a metal chloride was measured using an inductively coupled plasma (ICP) optical emission spectrometer (a lower detection limit value was 1 ppb by mole).

### (2) Measurement for Carbon Concentration in Polycrystalline Silicon Produced Using Purified Trichlorosilane

A gas obtained by vaporizing trichlorosilane and mixing the trichlorosilane with hydrogen was thermally decomposed on a 10 mm square silicon core wire by a Siemens method, and silicon was deposited on the silicon core wire to undergo growth. The obtained polycrystalline silicon rod having a diameter of 30 mm was single-crystallized by a floating zone method (FZ method), and a carbon concentration in the single-crystal silicon was measured by a low temperature Fourier transform infrared spectrophotometer (FT-IR) (a detection limit value was 10 ppb-atom).

### (3) Production Condition for Crude Trichlorosilane

A mixed gas containing silicon tetrachloride and hydrogen was brought into contact with metallurgical grade silicon in a reactor at about 480° C. to 520° C., and the metallurgical grade silicon was hydrochlorinated to generate a gas containing trichlorosilane (SiHCl₃). The gas contained the silicon tetrachloride (SiCl₄) and dichlorosilane (SiH₂Cl₂), and impurities other than silicon in the metallurgical grade silicon were also hydrochlorinated in the reactor, resulting in trace components such as iron chloride (FeCl₃), aluminum chloride (AlCl₃), organic chlorosilanes, and various organic substances in the generated gas. As a composition of the raw materials used, the metallurgical grade silicon had a silicon concentration of 99 mass %, an iron concentration of 0.7 mass %, an aluminum concentration of 0.3 mass %, and a carbon concentration of 300 ppm by wt, and the silicon tetrachloride and the hydrogen had a purity of 99 mass % or more.

A reaction product gas containing the trichlorosilane was cooled to a temperature range of 0° C. to 20° C. to obtain a cooled condensate. The cooled condensate was fed to a crude trichlorosilane recovery column to separate the metal chloride such as iron chloride having a boiling point higher than that of silicon tetrachloride, thereby obtaining a crude trichlorosilane liquid.

As a composition of the obtained crude trichlorosilane liquid, a trichlorosilane concentration was 27.2 mol %, a silicon tetrachloride concentration was 72.3 mol %, a dichlorosilane concentration was 0.5 mol %, a methyldichlorosilane concentration was 15,000 ppb by mole, an isopentane concentration was 85 ppb by mole, and an iron chloride concentration and an aluminum chloride concentration were each 1 ppb by wt or less.

### Example 1

The crude trichlorosilane liquid was treated by being subjected to a distillation flow shown in FIG. 1.

### Distillation Columns

In the distillation flow shown in FIG. 1, as the pre-first distillation column 2 and the pre-second distillation column 8, a distillation column having a column diameter of 150 mm and a number of theoretical trays of 30 was used. As the first distillation column 14, a distillation column having a column diameter of 150 mm and a number of theoretical trays of 80 was used, and as the second distillation column 20, a distillation column having a column diameter of 150 mm and a number of theoretical trays of 85 was used.

### Operating Condition of Each Distillation Column

The pre-first distillation column 2 was operated under conditions of a column bottom pressure of 200 kPa (gauge pressure) and a column bottom portion temperature of 91° C. to 92° C. The pre-second distillation column 8 was operated under conditions of a column top pressure of 100 kPa (gauge pressure) and a column top portion temperature of 41° C. to 42° C. The first distillation column 14 was operated under conditions of a column top pressure of 100 kPa (gauge pressure) and a column top portion temperature of 51° C. to 52° C. The second distillation column 20 was operated under conditions of a column bottom pressure of 200 kPa (gauge pressure) and a column bottom portion temperature of 65° C. to 66° C.

### Checking Impurity Removal Result in Each Distillation Column

After the operation under each of the above conditions had stabilized, a sample was taken at each point in the distillation flow and the composition thereof was analyzed.

### Pre-First Distillation Column 2

When the column bottom liquid flowing through the silicon tetrachloride-concentrated column bottom liquid extraction pipe 3 was sampled and analyzed for the composition, the silicon tetrachloride concentration was 99.9 mol % and the trichlorosilane concentration was equal to or less than the detection limit value of 10 ppm by mole. The silicon tetrachloride concentration in the column bottom liquid was 1.38 times higher than the silicon tetrachloride concentration in the crude trichlorosilane, indicating that by the distillation operation in the pre-first distillation column 2, in the trichlorosilane distilled from the top of the column and flowing through the silicon tetrachloride-reduced trichlorosilane distillation pipe 4, the silicon tetrachloride serving as an impurity was highly removed.

### Pre-Second Distillation Column 8

When the dichlorosilane concentrate flowing through the dichlorosilane concentrate flow pipe 13 was sampled and analyzed for the composition, the dichlorosilane concentration was 81 mol %, the trichlorosilane concentration was 19 mol %, and the silicon tetrachloride concentration was equal to or less than the detection limit value of 10 ppm by mole. The dichlorosilane concentrate had a dichlorosilane concentration 162 times higher than the dichlorosilane concentrate in the crude trichlorosilane, indicating that by the distillation operation in the pre-second distillation column 8, in the trichlorosilane extracted from the bottom of the column and flowing through the pre-purified trichlorosilane extraction pipe 9, the dichlorosilane serving as an impurity was highly removed. In fact, when a sample was taken from the pre-purified trichlorosilane extraction pipe 9 and the composition of the sample was analyzed, the dichlorosilane and the silicon tetrachloride were equal to or less than the detection limit value of 10 ppm by mole, the trichlorosilane concentration was 99.9 mol %, the methyldichlorosilane concentration was 15,000 ppb by mole, and the isopentane concentration was 85 ppb by mole.

### First Distillation Column 14

When the isopentane concentrate flowing through the isopentane concentrate flow pipe 19 was sampled and analyzed for the composition, the trichlorosilane concentration was 99.9 mol %, the isopentane concentration was 23,000 ppb by mole, and the methyldichlorosilane concentration was 3 ppb by mole. The isopentane concentrate had an isopentane concentration 270 times higher than the isopentane concentration in the crude trichlorosilane (pre-purified trichlorosilane), indicating that by the distillation operation in the first distillation column 14, in the trichlorosilane extracted from the bottom of the column and flowing through the isopentane-reduced trichlorosilane extraction pipe 15, the isopentane serving as an impurity was highly removed. In fact, when a sample was taken from the isopentane-reduced trichlorosilane extraction pipe 15 and the composition of the sample was analyzed, the trichlorosilane concentration was 99.9 mol %, the isopentane concentration was 17 ppb by mole, and the methyldichlorosilane concentration was 15,000 ppb by mole.

### Second Distillation Column 20

When the column bottom liquid flowing through the methyldichlorosilane-concentrated column bottom liquid extraction pipe 21 was sampled and analyzed for the composition, the trichlorosilane concentration was 99.9 mol %, the isopentane concentration was 17 ppb by mole, and the methyldichlorosilane concentration was 33,000 ppb by mole. The methyldichlorosilane concentration in the column bottom liquid was 2.2 times higher than the methyldichlorosilane concentration in the crude trichlorosilane (pre-purified trichlorosilane), indicating that by the distillation operation in the second distillation column 20, in the trichlorosilane distilled from the top of the column and flowing through the purified trichlorosilane distillation pipe 22, the methyldichlorosilane serving as an impurity was highly removed. In fact, when a sample was taken from the purified trichlorosilane flow pipe 25 and the composition of the obtained purified trichlorosilane was analyzed, a high-purity trichlorosilane was obtained in which the trichlorosilane concentration was 99.9 mol %, the isopentane concentration was 17 ppb by mole, and the methyldichlorosilane concentration was 72 ppb by mole.

### Checking Carbon Concentration in Polycrystalline Silicon Produced Using Trichlorosilane

Polycrystalline silicon was produced using the obtained purified trichlorosilane, and the carbon concentration was measured and found to be a low content of 30 ppb by mole.

### Comparative Example 1

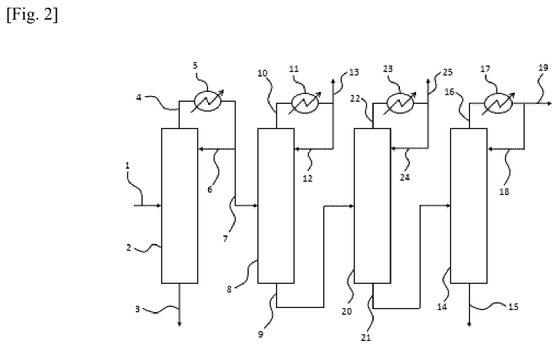

Purified trichlorosilane was produced in the same manner as in Example 1, except that a crude trichlorosilane liquid was treated by being subjected to a distillation flow changed from that shown in FIG. 1 to that shown in FIG. 2. The distillation flow in FIG. 2 had a step different from that in FIG. 1 in the following point, and other than this, a design of [Distillation Column] and [Operation Condition thereof] were substantially the same. That is, in FIG. 1, the distillation of the crude trichlorosilane (pre-purified trichlorosilane) was performed by distilling the isopentane concentrate from the top of the column in the first distillation column 14 to obtain the isopentane-reduced trichlorosilane from the bottom of the column, supplying the isopentane-reduced trichlorosilane to the second distillation column 20, and extracting the methyldichlorosilane-concentrated column bottom liquid in the column to distill the purified trichlorosilane from the top of the column in the second distillation column 20, while in FIG. 2, these removal targets were switched, the methyldichlorosilane-concentrated column bottom liquid was extracted to distill the methyldichlorosilane-reduced trichlorosilane from the top of the column in the second distillation column 20, the methyldichlorosilane-reduced trichlorosilane was supplied to the first distillation column 14, and the isopentane concentrate was distilled from the top of the column in the first distillation column 14 to obtain the purified trichlorosilane from the bottom of the column.

### Checking Impurity Removal Result in Each Distillation Column

Results in (Pre-first Distillation Column 2) and (Pre-second Distillation Column 8) were the same as those in Example 1 due to the same step.

### Second Distillation Column 20

When the column bottom liquid flowing through the methyldichlorosilane-concentrated column bottom liquid extraction pipe 21 was sampled and analyzed for the composition, the trichlorosilane concentration was 99.9 mol %, the isopentane concentration was 85 ppb by mole, and the methyldichlorosilane concentration was 33,000 ppb by mole. The methyldichlorosilane concentration in the column bottom liquid was 2.2 times higher than the methyldichlorosilane concentration in the crude trichlorosilane (pre-purified trichlorosilane), indicating that even when the methyldichlorosilane was removed first, in the trichlorosilane distilled from the top of the second distillation column 20 and flowing through the methyldichlorosilane-reduced trichlorosilane distillation pipe 22, the methyldichlorosilane serving as an impurity was highly removed. In fact, when a sample was taken from the methyldichlorosilane-reduced trichlorosilane supply pipe 21 and analyzed for the composition, the trichlorosilane concentration was 99.9 mol %, the isopentane concentration was 85 ppb by mole, and the methyldichlorosilane concentration was 73 ppb by mole.

### First Distillation Column 14

When the isopentane concentrate flowing through the isopentane concentrate flow pipe 19 was sampled and analyzed for the composition, the trichlorosilane concentration was 99.9 mol %, the isopentane concentration was 13,000 ppb by mole, and the methyldichlorosilane concentration was 73 ppb by mole. The isopentane concentrate had an isopentane concentration 152 times higher than the isopentane concentration in the crude trichlorosilane (pre-purified trichlorosilane), indicating that by the distillation operation in the first distillation column 14, in the trichlorosilane extracted from the bottom of the column and flowing through the purified trichlorosilane extraction pipe 15, the isopentane was highly removed. In fact, when a sample was taken from the purified trichlorosilane extraction pipe 15 and analyzed for the composition, the trichlorosilane concentration was 99.9 mol %, the isopentane concentration was 18 ppb by mole, and the methyldichlorosilane concentration was 73 ppb by mole. In measurements using GCMS, both the isopentane concentration and the methyldichlorosilane concentration were reduced to an extent close to those in the purified trichlorosilane produced in Example 1.

### Checking Carbon Concentration in Polycrystalline Silicon Produced Using Trichlorosilane

Polycrystalline silicon was produced using the obtained purified trichlorosilane, and the carbon concentration was measured to be a content of 610 ppb by mole, which was significantly higher than that of the polycrystalline silicon produced from the purified trichlorosilane produced in Example 1.

The cause is predicted to be that, in Example 1, the distillation of the isopentane in the first distillation column 14 is performed in the presence of the methyldichlorosilane, and in this state, the isopentane is also removed as an azeotrope, while in Comparative Example 1, since most of the methyldichlorosilane has been removed in the second distillation column 20 upstream of the first distillation column 14, removal of the azeotrope of the isopentane is insufficient in the distillation of the isopentane in the first distillation column 14. That is, in the absence of the methyldichlorosilane, most of the isopentane forms an azeotrope with the trichlorosilane, and the boiling point of the azeotrope is closer to the boiling point of the trichlorosilane than the boiling point of the isopentane, and thus the azeotrope is not sufficiently removed in the first distillation column 14. Accordingly, even when the purified trichlorosilane in which the isopentane concentration is measured to be as low as that in Example 1 is used, it is inferred that the polycrystalline silicon produced thereby contains carbon derived from the azeotrope, resulting in a high carbon concentration.

### Reference Signs List

1 Crude trichlorosilane flow pipe
2 Pre-first distillation column
3 Silicon tetrachloride-concentrated column bottom liquid extraction pipe
4 Silicon tetrachloride-reduced trichlorosilane distillation pipe
5, 11, 17, 23 Condenser
6 Silicon tetrachloride-reduced trichlorosilane reflux pipe
7 Silicon tetrachloride-reduced trichlorosilane supply pipe
8 Pre-second distillation column
9 Pre-purified trichlorosilane extraction pipe
10 Dichlorosilane concentrate distillation pipe
12 Dichlorosilane concentrate reflux pipe
13 Dichlorosilane concentrate flow pipe
14 First distillation column
15 Isopentane-reduced trichlorosilane extraction pipe (purified trichlorosilane extraction pipe)
16 Isopentane concentrate distillation pipe
18 Isopentane concentrate reflux pipe
19 Isopentane concentrate flow pipe
20 Second distillation column
21 Methyldichlorosilane-concentrated column bottom liquid extraction pipe (methyldichlorosilane-reduced trichlorosilane supply pipe)
22 Purified trichlorosilane distillation pipe (methyldichlorosilane-reduced trichlorosilane distillation pipe)
24 Purified trichlorosilane reflux pipe
25 Purified trichlorosilane flow pipe

1. A method for producing purified trichlorosilane, comprising:
supplying crude trichlorosilane containing at least isopentane and methyldichlorosilane to a first distillation column, purifying the crude trichlorosilane by distillation in a manner that a low boiling point fraction having an isopentane concentration 150 times or more higher than an isopentane concentration in the crude trichlorosilane is discharged, and extracting trichlorosilane having a reduced isopentane concentration from a bottom of the column; and
supplying the obtained trichlorosilane having a reduced isopentane concentration to a second distillation column, purifying the obtained trichlorosilane having a reduced isopentane concentration by distillation in a manner that a high boiling point fraction having a methyldichlorosilane concentration 1.5 times or more higher than a methyldichlorosilane concentration in the crude trichlorosilane is discharged, and
distilling off purified trichlorosilane having a reduced methyldichlorosilane concentration from a top of the column.

2. The method for producing purified trichlorosilane according to claim 1, wherein in the crude trichlorosilane, a content of the isopentane is 30 ppb by mole or more, and in the trichlorosilane having a reduced isopentane concentration, a content of the isopentane is 20 ppb by mole or less.

3. The method for producing purified trichlorosilane according to claim 1, wherein in the crude trichlorosilane, a content of the methyldichlorosilane is 1 ppm by mole or more, and in the purified trichlorosilane having a reduced methyldichlorosilane concentration, a content of the methyldichlorosilane is 100 ppb by mole or less.

4. The method for producing purified trichlorosilane according to claim 1, wherein the crude trichlorosilane further contains silicon tetrachloride and dichlorosilane said method further comprising:
supplying the crude trichlorosilane to a pre-first distillation column, and purifying by distillation in a manner that a high boiling point fraction having a silicon tetrachloride concentration 1.1 times or more higher than a silicon tetrachloride concentration in the crude trichlorosilane is discharged, and distilling crude trichlorosilane having a reduced silicon tetrachloride concentration from a top of the column, and
supplying the obtained crude trichlorosilane having a reduced silicon tetrachloride concentration to a pre-second distillation column, and purifying by distillation in a manner that a low boiling point fraction having a dichlorosilane concentration 100 times or more higher than a dichlorosilane concentration in the crude trichlorosilane is discharged, and
extracting crude trichlorosilane having a reduced dichlorosilane concentration from a bottom of the column and supplying to the first distillation column.

5. The method for producing purified trichlorosilane according to claim 4, wherein in the crude trichlorosilane, a content of the silicon tetrachloride is 70 mol % or more, and in the crude trichlorosilane having a reduced silicon tetrachloride concentration, a content of the silicon tetrachloride is 10 ppm by mole or less.

6. The method for producing purified trichlorosilane according to claim 4, wherein in the crude trichlorosilane, a content of the dichlorosilane is 0.1 mol % or more, and in the crude trichlorosilane having a reduced dichlorosilane concentration, a content of the dichlorosilane is 10 ppm by mole or less.

7. The method for producing purified trichlorosilane according to claim 1, wherein the crude trichlorosilane is generated by reacting a gas containing hydrogen chloride or silicon tetrachloride and hydrogen with metallurgical grade silicon.

8. A method for producing purified trichlorosilane, comprising:
purifying crude trichlorosilane that contains isopentane and methyldichlorosilane and has a trichlorosilane concentration of 99% mol or more, wherein
a distillation operation of removing the isopentane is performed before performing a distillation operation of removing the methyldichlorosilane from the crude trichlorosilane.
